(19) United States
(12) Patent Application Publication
(10) Pub. No.: US 2022/0163103 A1
(43) Pub. Date: May 26, 2022

(54) FINAL REDUCTION APPARATUS

(71) Applicant: GKN Automotive Limited, Birmingham (GB)

(72) Inventors: Masato Horiguchi, Tochigi-shi (JP); Manabu Endou, Tochigi-shi (JP)

(21) Appl. No.: 17/520,976

(22) Filed: Nov. 8, 2021

(30) Foreign Application Priority Data
Nov. 25, 2020 (JP) 2020-195154

(51) Int. Cl. F16H 48/30; F16H 48/40; F16H 48/08; F16H 57/08

(52) U.S. Cl. CPC F16H 48/30; F16H 57/082; F16H 48/08; F16H 48/40

(57) ABSTRACT

A final reduction apparatus includes a carrier, a differential device, a clutch member for interrupting a differential movement of the differential device, and an actuator for operating the clutch member. The clutch member is accommodated in a differential case of the differential device. The actuator is disposed outside the differential case. The carrier includes a main body in which an opening is formed and a cover that closes the opening. The differential device is insertable via the opening into the main body. The actuator is disposed on a side of the cover that is, on an opposite side of the actuator with respect to the opening than the differential device.

### CROSS-REFERENCE TO RELATED APPLICATIONS

This application is based on, and under 35 USC 119 claims priority from, Japanese Patent Application No. 2020-195154 filed on Nov. 25, 2020, the contents of which are incorporated herein by reference in its entirety.

### BACKGROUND

JP-A-2017-067257 discloses a final reduction apparatus including a carrier, a differential device including a differential case that is rotatably supported by the carrier and to which a driving force is input, a differential gear that is rotatably supported by the differential case and that is rotatable by the rotation of the differential case, and a pair of output gears that mesh with the differential gear and are rotatable relative to each other, and that output a driving force, a clutch member that is accommodated in the differential case and interrupts a differential movement of the differential device, and an actuator that is disposed outside the differential case and operates the clutch member.

In the final reduction apparatus, the carrier includes a first carrier that mainly accommodates the actuator and a second carrier that mainly accommodates the differential device. The first carrier and the second carrier are provided with a dividing surface along a direction orthogonal to a rotational axis of the differential case.

In the final reduction apparatus, the differential device and the actuator are temporarily assembled, and are inserted into and accommodated in an opening of the dividing surface of the first carrier from a side of an actuator. Then, the second carrier is aligned with the dividing surface of the first carrier, and the first carrier and the second carrier are fixed to each other by a fixing means such as a bolt.

In the final reduction apparatus, since the actuator is disposed in a back portion from the opening of the first carrier, it is difficult to visually recognize an arrangement position of the actuator from the opening. Therefore, it is difficult to dispose the actuator at an accurate position of the carrier, and ease of assembly is reduced.

### SUMMARY

The present disclosure relates to a final reduction apparatus applied to a vehicle and that can improve ease of assembly.

A final reduction apparatus includes a carrier, a differential device, a clutch member, and an actuator. The differential device includes a differential case which is rotatably supported by the carrier and to which a driving force can be input. A differential gear is rotatably supported by the differential case and is rotatable by a rotation of the differential case. A pair of output gears that mesh with the differential gear are rotatable relative to each other and respectively output driving force. The clutch member is accommodated in the differential case and is configured to interrupt a differential movement of the differential device. The actuator is disposed outside the differential case and configured to operate the clutch member. The carrier includes a main body in which an opening is formed and a cover that closes the opening of the main body. The differential device is accommodated in the main body. The differential device is capable of being accommodated from the opening into the main body. The actuator is disposed on a side of the cover with respect to the opening of the main body, that is, on an opposite side of the actuator with respect to the opening than the differential device.

### BRIEF DESCRIPTION OF DRAWING

FIG. 1 is a cross-sectional view of a final reduction apparatus.

### DESCRIPTION

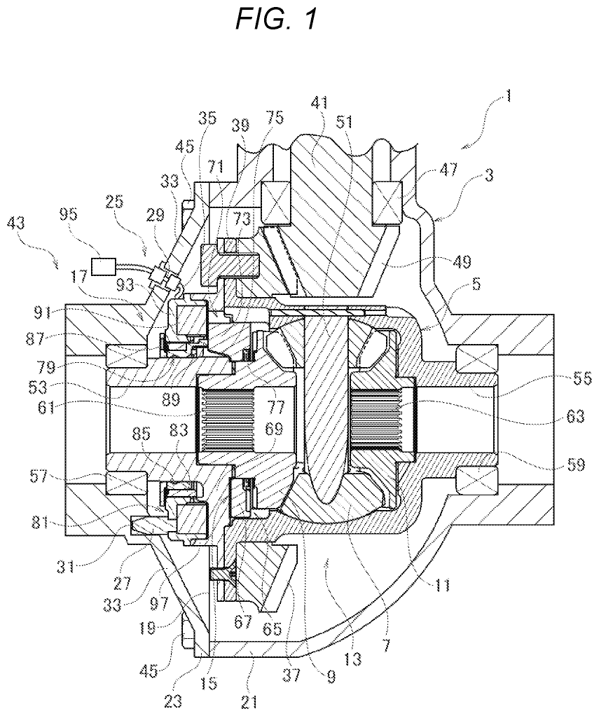

A final reduction apparatus according to the present disclosure will be described with reference to FIG. 1.

A final reduction apparatus 1 includes a carrier 3, a differential device 13 including a differential case 5 that is rotatably supported by the carrier 3 and to which a driving force can be input, differential gears 7 that are rotatably supported by the differential case 5 and that are rotatable by the rotation of the differential case 5, and a pair of output gears 9, 11 that mesh with the differential gears 7 and are rotatable relative to each other, and output a driving force, a clutch member 15 that is accommodated in the differential case 5 and interrupts a differential movement of the differential device 13, and an actuator 17 that is disposed outside the differential case 5 and operates the clutch member 15.

Further, the carrier 3 includes a main body 21 and a cover 23. In the main body 21, an opening 19 capable of accommodating the differential device 13 is formed. The differential device 13 is accommodated in the main body 21. The cover 23 closes the opening 19 of the main body 21.

The actuator 17 is disposed on a side of the cover 23 with respect to the opening 19 of the main body 21.

Further, the actuator 17 is provided with an electrical connection portion 25 that is electrically connected to a controller disposed outside the carrier 3, and a rotation prevention portion 27 that is prevented from rotating with respect to the carrier 3.

The cover 23 is provided with an electrical arrangement portion 29 in which the electrical connection portion 25 is disposed, and an engagement portion 31 that is engaged with the rotation prevention portion 27.

Further, the cover 23 is provided with an enlarged portion 33 that is radially enlarged from the electrical arrangement portion 29 and the engagement portion 31 toward a side of the opening 19 of the main body 21.

The actuator 17 is supported by the differential case 5. Further, a lead wire 35 having a predetermined extension allowance is electrically connected to the electrical connection portion 25 between the actuator 17 and the cover 23.

The rotation prevention portion 27 has a predetermined length in a rotation axis direction of the differential case 5 and is engaged with the engagement portion 31.

The differential case 5 is provided with a flange portion 39 to which an input gear 37, to which the driving force is input, is fixed.

The flange portion 39 is disposed on a side of a main body 21 with respect to the opening 19 of the main body 21.

As illustrated in FIG. 1, the final reduction apparatus 1 includes the carrier 3, an input member 41, the differential device 13, and an interrupting mechanism 43.

The carrier 3 includes the main body 21 that has an accommodation space for mainly accommodating the input member 41 and the differential device 13, and the cover 23 that has an accommodation space for mainly accommodating the actuator 17.

The main body 21 is formed with the opening 19 into which the differential device 13 can be inserted from the rotation axis direction of the differential case 5. The opening 19 is formed along a direction orthogonal (i.e., perpendicular) to the rotation axis direction of the differential case 5.

Each member is accommodated in the main body 21 through the opening 19, and the opening 19 is closed by the cover 23. The cover 23 is attached to the main body 21 via a plurality of bolts 45 arranged in a circumferential direction around a rotation axis of the differential case 5.

The input member 41, the differential device 13, the interrupting mechanism 43, or the like are accommodated in the carrier 3.

The input member 41 is formed in a shaft shape whose axis is disposed in a direction orthogonal to the rotation axis of the differential case 5. Both sides of the input member 41 in the axial direction are rotatably supported by the main body of the carrier 3 via bearings 47 (only one is illustrated).

One end side of the input member 41 in its axial direction is connected to an input-side mechanism such as a propeller shaft that transmits a driving force from a side of a drive source so as to be integrally rotatable.

A small-diameter gear portion 49 is provided on a side of the other end of the input member 41 in the axial direction. The gear portion 49 meshes with the large-diameter input gear 37 fixed to the differential case 5 to form a direction changing gear set. For example, the gear portion 49 changes a direction of the driving force transmitted from a side of the driving source while changing the speed of the driving force, and transmits the driving force to the differential device 13.

The differential device 13 includes the differential case 5, a pinion shaft 51, the differential gears 7, and the pair of output gears 9, 11.

The differential case 5 is rotatably supported by the cover 23 and the main body 21 of the carrier 3 via bearings 57, 59, respectively, on the outer peripheries of boss portions 53, 55 provided on both sides in the axial direction.

The differential case 5 is provided with the flange portion 39 to which the input gear 37 is fixed via bolts. The input gear 37 meshes with the gear portion 49 of the input member 41, and the driving force from the drive source is transmitted to the differential case 5.

The pinion shaft 51, the differential gears 7, and the pair of output gears 9, 11 are accommodated in the differential case 5, and the driving force input to the differential case 5 is transmitted.

One end portion of the pinion shaft 51 is engaged with the differential case 5, and the pinion shaft 51 is prevented from coming off and rotating by a pin, and is driven to rotate integrally with the differential case 5. The plurality of differential gears 7 are respectively supported on both end sides of the pinion shaft 51.

Two differential gears 7 are arranged at equal intervals in the circumferential direction of the differential case 5, are supported on both end sides of the pinion shaft 51, and rotate by the rotation of the differential case 5.

The differential gear 7 is rotatably supported by the pinion shaft 51 so as to transmit the driving force to the pair of output gears 9, 11 and to be rotationally driven when differential rotation occurs between the pair of output gears 9, 11 that mesh with the differential gear 7.

The pair of output gears 9, 11 are supported by the differential case 5 at boss portions respectively formed on the output gears 9, 11 so that the output gears 9, 11 are rotatable relative to each other. The output gears 9, 11 respectively mesh with the differential gear 7.

The pair of output gears 9, 11 are respectively provided with spline-shaped connecting portions 61, 63 on inner peripheral sides. Further, for example, drive shafts connected to mechanisms on an output side such as left and right wheels, so as to be integrally rotatable, are respectively connected to the output gears 9, 11 so as to be integrally rotatable, and the drive force input to the differential case 5 is output to the mechanisms on the output side.

A differential movement between the pair of output gears 9, 11 in the differential device 13 is locked by the connection of the interrupting mechanism 43, and the driving force transmitted to the pair of output gears 9, 11 is uniformly output to the mechanisms on the output side.

In this way, the final reduction apparatus 1 including the interrupting mechanism 43 for interrupting the differential operation of the differential device 13 is a differential device having a so-called differential lock function.

The interrupting mechanism 43 includes the clutch member 15, interrupting portions 65, and the actuator 17.

The clutch member 15 is formed into an annular shape, and a base portion 67 formed of a member continuous in a circumferential direction of the clutch member 15 is disposed between a wall portion 69 of the differential case 5 and a rear surface side of the output gear 9 in an axial direction so as to be movable in the axial direction.

An engagement portion 71 that engages with the differential case 5 so as to be rotatable integrally with the differential case 5 is provided on the clutch member 15 at a side of a wall portion 69 of the differential case 5, and the interrupting portions 65 are provided between the clutch member 15 and a rear surface side the output gear 9.

The engagement portion 71 includes a plurality of convex portions 73 provided on the base portion 67 of the clutch member 15 at equal intervals in the circumferential direction, and further includes a plurality of holes 75 provided in the wall portion 69 of the differential case 5 at equal intervals in the circumferential direction so as to pass through the wall portion 69 in the axial direction.

When the convex portions 73 and the holes 75 engage with one another in a rotation direction, the clutch member 15 is prevented from rotating with respect to the differential case 5, and the clutch member 15 and the differential case 5 can be integrally rotated.

The engagement portion 71 is provided with a cam that moves the clutch member 15 in a connection direction of the interrupting portions 65. The cam has cam surfaces having a same inclination formed on opposing surfaces of the convex portion 73 and the hole portion 75 on both sides in a circumferential direction.

Therefore, the cam surfaces engage with one another by a rotation of the differential case 5 when the clutch member 15 is moved in the connection direction of the interrupting portions 65 and an engagement action occurs in the interrupting portion 65 in the rotation direction, so that the clutch member 15 is further moved in a meshing direction of the interrupting portions 65 to strengthen the connection of the interrupting portions 65.

The interrupting portions 65 are provided between the clutch member 15 and the rear surface side of the output gear 9 in the axial direction on a side surface of the base portion 67 of the clutch member 15 opposite to the engagement portion 71 in the axial direction, and the plurality of interrupting portions 65 are formed on each of the clutch member 15 and the output gear 9, and serve as engagement teeth that engage with one another.

The engagement teeth of the interrupting portions 65 engage with one another, so that the clutch member 15 and the output gear 9 are connected to each other so as to be integrally rotatable; that is, the differential case 5 and the output gear 9 are connected to each other so as to be integrally rotatable, and the differential of the differential device 13 is brought into a locked state.

On the other hand, a biasing member 77 is provided on a radially inner side of the interrupting portion 65 between the clutch member 15 and the rear surface side of the output gear 9 in the axial direction, and constantly biases the clutch member 15 in a disconnection direction of the interrupting portion 65.

The biasing member 77 moves the clutch member 15 in the disconnection direction of the interrupting portion 65, the interrupting portion 65 is disconnected, and the differential of the differential device 13 is brought into an unlocked state.

The interrupted state of the interrupting portion 65 is controlled by the actuator 17. The actuator 17 includes a movable member 79 and an electromagnet 81.

The movable member 79 is disposed on an inner diameter side of the electromagnet 81 so as to be movable in the axial direction on an outer periphery of the boss portion 53 of the differential case 5. The movable member 79 includes an annular plunger 83 and a ring member 85.

The plunger 83 is formed of a magnetic material, and is disposed on the inner diameter side of the electromagnet 81 with an air gap that is a minute gap sized to allow a magnetic flux to pass through.

The ring member 85 is formed of a non-magnetic material and integrally fixed to an inner diameter side of the plunger 83. The ring member 85 prevents the magnetic flux from leaking from an inner peripheral side of the plunger 83 to a side of a differential case 5.

The ring member 85 is disposed on an outer periphery of the boss portion 53 of the differential case 5 so as to be movable in the axial direction. The ring member 85 is prevented from moving axially outward by a restriction member 87 formed of a non-magnetic material and press-fitted and fixed to the outer periphery of the boss portion 53 of the differential case 5.

An axial end surface of the ring member 85 on a side of a clutch member 15 is provided with a pressing portion 89 that is capable of abutting against the convex portion 73 of the clutch member 15.

The pressing portion 89 transmits a moving operation force in the axial direction by the movable member 79 operated by the electromagnet 81 to the clutch member 15 via the pressing portion 89, and presses the clutch member 15 in the connection direction of the interrupting portion 65.

The electromagnet 81 is disposed adjacent to the wall portion 69 of the differential case 5 in the axial direction on an outer peripheral side of the boss portion 53 of the differential case 5.

The rotation prevention portion 27 is integrally fixed to the electromagnet 81, and is engaged with the engagement portion 31 formed in the cover 23 of the carrier 3, so that the rotation thereof is prevented. The electromagnet 81 includes an electromagnetic coil 91 and a core 93.

The electromagnetic coil 91 is annularly wound by a predetermined number of turns and is molded using a resin. A lead wire 35 drawn out to the outside of the core 93 is electrically connected to the electromagnetic coil 91, and an end portion of the lead wire 35 drawn out from the core 93 is electrically connected to the electrical connection portion 25.

The electrical connection portion 25 is disposed in the electrical arrangement portion 29 formed of a through hole formed in the cover 23 of the carrier 3, and a connector portion 95 is drawn out to the outside of the carrier 3.

A mating connector portion (not illustrated) electrically connected to a controller (not illustrated) is fitted to the connector portion 95, the electromagnet 81 is electrically connected to the controller via the electrical connection portion 25, and energization of the electromagnet 81 is controlled.

The core 93 is formed of a magnetic material such that a magnetic field is formed by energization of the electromagnetic coil 91, and has a predetermined magnetic path cross-sectional area. The core 93 annularly covers inner and outer peripheral surfaces of the electromagnetic coil 91 and an end surface in the axial direction of the electromagnetic coil 91 positioned at an opposite side to the wall portion 69 of the differential case 5.

An extending portion 97 extending in the axial direction from the wall portion 69 of the differential case 5 is disposed on an outer diameter side of the core 93, so as to cover a sliding contact surface through which a magnetic flux can pass. An end surface in an axial direction of the extending portion 97 is disposed so as to be capable of abutting against a convex portion provided on an outer diameter of the core 93, and is positioned inward in the axial direction of the electromagnet 81.

On the other hand, an end surface at an outer side in an axial direction of the core 93 is positioned toward an outer side in the axial direction of the electromagnet 81 together with the movable member 79 by the restriction member 87 that is press-fitted and fixed to the boss portion 53 of the differential case 5 and that prevents the movable member 79 from moving to the outer side in the axial direction.

In the final reduction apparatus 1 configured as described above, by effectively using the shortest magnetic flux loop formed by the magnetic flux passing through the core 93, the plunger 83, and the wall portion 69 of the differential case 5 upon the excitation of the electromagnet 81, the plunger 83 is moved toward a side of the clutch member 15, and the ring member 85 presses the clutch member 15 via the pressing portion 89.

When the movable member 79 presses the clutch member 15, the clutch member 15 is moved in the connection direction of the interrupting portion 65 against a biasing force of the biasing member 77, and the interrupting portion 65 is connected.

When the interrupting portion 65 is connected, the output gear 9 and the clutch member 15 are connected to each other so as to be rotated integrally, the output gear 9 and the differential case 5 are connected to each other, and the differential device 13 is brought into a locked state.

On the other hand, when the energization to the electromagnet 81 is stopped, the clutch member 15 is moved in a disconnection direction of the interrupting portion 65 by the biasing force of the biasing member 77, and the interrupting portion 65 is disconnected.

When the interrupting portion 65 is disconnected, the output gear 9 and the clutch member 15 can be rotated relative to each other, the output gear 9 and the differential case 5 can be rotated relative to each other, and the differential device 13 is brought into an unlocked state.

In the final reduction apparatus 1, in the installation of the members into the carrier 3, whereby the members are accommodated in the carrier 3, the actuator 17 is assembled in advance on the outer periphery of the boss portion 53 of the differential case 5 so as to be supported. Next, the input member 41 is attached to the main body 21 of the carrier 3.

Next, the differential case 5 on which the actuator 17 is supported is inserted via the opening 19 of the main body 21 such that the input gear 37 meshes with the gear portion 49 of the input member 41, and is accommodated in the main body 21.

Then, the cover 23 is aligned so as to close the opening 19 of the main body 21, and the cover 23 is fixed to the main body 21 by the plurality of bolts 45.

In such assembly, when the actuator 17 is disposed on a side of a boss portion 55 of the differential case 5, it is difficult to visually recognize the actuator 17 via the opening 19 of the main body 21, and it is difficult to confirm the engagement of the rotation prevention portion 27.

In addition, because positioning (or arranging) the electrical connection portion 25 of the actuator 17 must also be performed from the opening 19 of the main body 21, and is performed so as to avoid interference with the input gear 37 and the gear portion 49 of the input member 41, the positioning of the connection portion 25 becomes complicated.

Therefore, the actuator 17 is disposed on a side of the cover 23 with respect to the opening 19 of the main body 21 in a state where the main body 21 of the carrier 3 and the cover 23 are assembled.

Further, the cover 23 is provided with the electrical arrangement portion 29 in which the electrical connection portion 25 of the actuator 17 is disposed, and the engagement portion 31 with which the rotation prevention portion 27 is engaged.

Therefore, in a state where the differential case 5 supporting the actuator 17 is accommodated in the main body 21 of the carrier 3, the actuator 17 is exposed from the opening 19 of the main body 21.

In a state where the actuator 17 is exposed from the main body 21, when the cover 23 is assembled to the main body 21, the engagement between the rotation prevention portion 27 of the actuator 17 and the engagement portion 31 of the cover 23 can be easily visually recognized from the opening 19, and the rotation prevention portion 27 and the engagement portion 31 can be easily engaged with each other.

Further, in a state where the actuator 17 is exposed from the main body 21, when the cover 23 is assembled to the main body 21, the electrical connection portion 25 of the actuator 17 is easily disposed in the electrical arrangement portion 29 of the cover 23 from the opening 19, and the positioning work can be easily performed.

Here, the cover 23 is provided with the enlarged portion 33 radially enlarged from the electrical arrangement portion 29 and the engagement portion 31 toward a side of the opening 19 of the main body 21.

The enlarged portion 33 is a peripheral wall constituting the cover 23, and is inclined downward from an outer diameter side toward an inner diameter side when viewed from a side of the opening 19 of the main body 21.

By providing the enlarged portion 33, when the cover 23 is attached to the main body 21, the electrical arrangement portion 29 and the engagement portion 31 can be easily visually recognized via the opening 19, and the assembling work can be easily performed.

The flange portion 39 to which the input gear 37 of the differential case 5 is fixed is disposed on a side of the main body 21 with respect to the opening 19 of the main body 21.

By disposing the flange portion 39 in this manner, the flange portion 39 is not exposed from the opening 19 of the main body 21 in a state where the differential case 5 on which the actuator 17 is supported is accommodated in the main body 21 of the carrier 3.

Therefore, when the actuator 17 is viewed from the opening 19, the input gear 37 does not make it difficult to view the actuator 17, and an arrangement position of the actuator 17 with respect to the carrier 3 can be easily visually recognized.

In addition, when the cover 23 is assembled to the main body 21, the input gear 37 does not interfere with the visual recognition of the engagement of the rotation prevention portion 27 and the arrangement work of the electrical connection portion 25, and the ease of assembly can be improved.

Further, since the flange portion 39 is disposed on a side of the opening 19, the engagement between the input gear 37 and the gear portion 49 of the input member 41 can be easily visually recognized through the opening 19.

Further, the lead wire 35 electrically connected to the electromagnet 81 of the actuator 17 is electrically connected to the electrical connection portion 25 with the predetermined extension allowance between the actuator 17 and the cover 23.

By providing the lead wire 35 with the predetermined extension allowance in this way, when the cover 23 is assembled to the main body 21, the electric connection portion 25 can be easily disposed in the electrical arrangement portion 29 from the opening 19 by the extension allowance of the lead wire 35, and the arrangement or positioning work can be further easily performed.

Further, the rotation prevention portion 27 provided at the electromagnet 81 of the actuator 17 has the predetermined length in the rotation axis direction of the differential case 5 and is engaged with the engagement portion 31.

In this way, since the rotation prevention portion 27 has a predetermined length in the rotation axis direction of the differential case 5, the rotation prevention portion 27 can be easily visually recognized from the opening 19 when the cover 23 is assembled to the main body 21, and the rotation prevention portion 27 can be stably engaged with the engagement portion 31.

In the final reduction apparatus 1, the carrier 3 includes the main body 21 in which the opening 19 capable of accommodating the differential device 13 is formed and the differential device 13 is accommodated, and further includes the cover 23 that closes the opening 19 of the main body 21. The actuator 17 is disposed on a side of the cover 23 with respect to the opening 19 of the main body 21, that is, the actuator 17 is on an opposite side of the opening 19 than the differential device 13, i.e., in the direction of the rotation axis.

With this configuration, in a state where the differential device 13 and the actuator 17 are accommodated in the main body 21 of the carrier 3, the actuator 17 is exposed from the opening 19 of the main body 21. Therefore, when the cover 23 is assembled to the main body 21, it is easy to visually recognize the arrangement position of the actuator 17, and it is easy to dispose the actuator 17 at an accurate position of the carrier 3.

Therefore, in the final reduction apparatus 1, the actuator 17 can be easily disposed at the accurate position of the carrier 3, and the ease of assembly can be improved.

Further, the cover 23 is provided with the electrical arrangement portion 29 in which the electrical connection portion 25 is disposed, and the engagement portion 31 that is engaged with the rotation prevention portion 27.

Therefore, when the cover 23 is assembled to the main body 21, it is possible to easily perform an arrangement work of disposing the electrical connection portion 25 in the electrical arrangement portion 29 from the opening 19. In addition, when the cover 23 is assembled to the main body 21, the engagement between the rotation prevention portion 27 and the engagement portion 31 can be easily visually recognized via the opening 19, and the rotation prevention portion 27 and the engagement portion 31 can be stably engaged with each other.

Further, the cover 23 is provided with the enlarged portion 33 radially enlarged from the electrical arrangement portion 29 and the engagement portion 31 toward a side of the opening 19 of the main body 21.

Therefore, when the cover 23 is assembled to the main body 21, the electrical arrangement portion 29 and the engagement portion 31 can be easily visually recognized from the opening 19, and the assembling work can be easily performed.

Further, the lead wire 35 having the predetermined extension allowance is electrically connected to the electrical connection portion 25 between the actuator 17 and the cover 23.

Therefore, when the cover 23 is assembled to the main body 21, the electric connection portion 25 can be easily disposed in the electrical arrangement portion 29 from the opening 19 by the extension allowance of the lead wire 35, and the arrangement work can be performed more easily.

Further, the rotation prevention portion 27 has the predetermined length in the rotation axis direction of the differential case 5 and is engaged with the engagement portion 31.

Therefore, when the cover 23 is assembled to the main body 21, it is easy to visually recognize the rotation prevention portion 27 via the opening 19, and the rotation prevention portion 27 and the engagement portion 31 can be more stably engaged with each other.

Further, the flange portion 39 is disposed on a side of the main body 21 with respect to the opening 19 of the main body 21.

Therefore, when the actuator 17 is viewed from the opening 19, the input gear 37 does not make it difficult to view the actuator 17, and the arrangement or position of the actuator 17 with respect to the carrier 3 can be easily visually recognized.

In the final reduction apparatus according to the present embodiment, the actuator is disposed on a side of the flange portion of the differential case, but the present invention is not limited thereto, and the actuator may be disposed on a side opposite to the flange portion of the differential case.

In this case, a mating surface between the main body of the carrier and the cover may be provided on the side opposite to the flange portion of the differential case, and the actuator may be disposed on a side of the cover of the carrier.

What is claimed is:

1. A final reduction apparatus comprising:
a carrier;
a differential device;
a clutch member; and
an actuator,
wherein the differential device includes:
a differential case that is rotatably supported by the carrier and arranged to receive a driving force;
a differential gear that is rotatably supported by the differential case and rotatable by a rotation of the differential case; and
a pair of output gears that mesh with the differential gear, that are rotatable relative to each other, and that respectively output driving force,
wherein the clutch member is accommodated in the differential case and is configured to interrupt a differential movement of the differential device,
wherein the actuator is disposed outside the differential case and configured to operate the clutch member,
wherein the carrier includes a main body in which an opening is formed and a cover that closes the opening of the main body,
wherein the differential device is accommodated in the main body,
wherein the differential device is insertable via the opening into the main body, and
wherein the actuator is disposed on a side of the cover on an opposite side of the actuator with respect to the opening than the differential device.

2. The final reduction apparatus according to claim 1,
wherein the actuator includes an electrical connection portion to be electrically coupled with a controller disposed outside the carrier, and a rotation prevention portion that is prevented from rotating with respect to the carrier, and
wherein the cover includes an electrical arrangement portion in which the electrical connection portion is disposed, and an engagement portion that is engaged with the rotation prevention portion.

3. The final reduction apparatus according to claim 2,
wherein the cover includes an enlarged portion that is radially enlarged from the electrical arrangement portion and the engagement portion toward a side of the opening of the main body.

4. The final reduction apparatus according to claim 2,
wherein the actuator is supported by the differential case,
wherein a lead wire having a predetermined extension allowance is electrically connected to the electrical connection portion between the actuator and the cover, and
wherein the rotation prevention portion has a predetermined length in a rotation axis direction of the differential case and is engaged with the engagement portion.

5. The final reduction apparatus according to claim 1,
wherein the differential case includes a flange portion to which an input gear to which the driving force is input is fixed, and
wherein the flange portion is disposed on a side of the cover with respect to the opening of the main body.
